(19) United States
(12) Patent Application Publication
(10) Pub. No.: US 2011/0121560 A1
(43) Pub. Date: May 26, 2011

(54) LATCH MECHANISM

(75) Inventor: Matthew Joseph Readman, Manchester (GB)

(73) Assignee: SELF-ENERGISING COUPLING COMPANY LIMITED, Northwich (GB)

(21) Appl. No.: 12/991,529

(22) PCT Filed: May 7, 2009
(86) PCT No.: PCT/GB2009/050472

§ 371 Date: Feb. 3, 2011

(30) Foreign Application Priority Data
May 7, 2008 (GB) 0808252.1

(51) Int. Cl. F16L 37/084; F16B 12/24; F16B 12/36; B23P 11/00

(52) U.S. Cl. 285/82; 403/361; 403/326; 29/428; 29/426.1

(57) ABSTRACT

A latch mechanism (10) comprises a male coupling member (12), and a female coupling member (14). The latch mechanism (10) is coupled/de-coupled by inserting/withdrawing male coupling member from female coupling member, by movement in a first direction A-A. A latch (20), here comprising a plate (44) and two prongs (42), is slidably mounted on the male coupling member (12), for movement in a second direction B-B. A compression spring (21) biases the latch (20) so that the prongs (42) are exposed at the distal end of the male coupling member (12). Catch channels shown here as two holes (22) that extend in the second direction B-B for receiving the prongs (42) are formed in the female coupling member. In use, the latch mechanism (10) is coupled by relative movement in the first direction between the male and female coupling members. When the probe is fully inserted, the prongs of the latch are aligned with the holes (22). Consequently, due to the bias of the spring (21), the prongs (42) enter the holes (22). Because the second direction is inclined to the first direction, when in the mated position, de-coupling of the latch mechanism by relative movement in the first direction A-A is prevented by engagement between the prongs (42) and the holes (22).

The present invention relates to a latch mechanism and in particular, although not exclusively, to a latch mechanism for a pipe coupling.

Latch mechanisms are widely used in many applications wherein two parts engage by sliding relative to each other and a latch secures the two parts to prevent disengagement unless the latch is first released. For instance, it is known for a pipe coupling to consist of a female coupling member that includes a socket and a male coupling member that includes a probe wherein the two coupling members are mated by inserting the probe into the socket. The mating of the male and female coupling members aligns two parts of a fluid conduit so that fluid may flow through the couplings. Once mated, a coupling pin is inserted through an aperture in the female coupling member and an aligned recess in the probe in order to lock the male and female coupling members together. The axis of the pin is arranged at right angles to the insertion axis.

To disengage the male and female coupling members, the pin is withdrawn from the recess in the probe to allow the probe to be withdrawn from the socket along the insertion axis. Accordingly, disengagement and mating of the coupling members requires two distinct movements.

It is an aim of the present invention to provide a push-pull latch mechanism that can be mated by pushing the male coupling member towards the female coupling member and can be disengaged by pulling the male coupling member away from the female coupling member both requiring only one movement.

A further application is in sub-sea moorings. Here a floating platform is secured to the sea bed by dropping anchoring ropes from the platform and connecting the ends of the ropes to an underwater platform. A known latch mechanism for connecting the ropes to the underwater platform is to form wedge-shaped radial notches in a probe of a male coupling. Ball bearings are housed in the notches and are freely movable within the wedged notches from the shallow end to the deep end. When the ball bearings are in the deep end, they do not extend substantially past the perimeter of the male coupling. To insert the probe into a socket, the ball bearings move to the deep end and the probe enters a socket of a female coupling. When inserted the ball bearings align with notches in the sockets internal wall. Accordingly, the ball bearings carry the separation load by wedging between the notches on the probe and the notches in the socket. To de-couple the latch, a cage, which encircles the probe in order to retain the ball bearings within the notches, is operable to move the ball bearings towards the deep end and therefore out of engagement with the notches in the socket.

Due to the tendency of the floating platform to move under tides, wind and/or surface water conditions, the ropes are often joined/de-coupled under load. It is not possible to join/de-couple the known latch mechanism under load. Accordingly, it is a further aim of the present to provide a latch mechanism that can be coupled and un-coupled under load.

According to the present invention there is provided an apparatus and method as set forth in the appended claims. Other features of the invention will be apparent from the dependent claims, and the description which follows.

In one aspect of the present invention, there is provided a latch mechanism for coupling a first part to a second part in a first coupling direction wherein one of the first or second parts includes a latch and the other of the first or second parts includes a catch channel, the latch and catch channel being arranged such that when the two parts are coupled the latch enters the catch channel in a second direction. The second direction is inclined to the first direction, preferably by an oblique angle. Accordingly, a latch mechanism is provided that may suitably be used in any number of applications, for instance sliding doors, flat packed furniture joints and the alike. Preferably the latch mechanism may include a number of latches. Each latch may be angled to the first direction at a same or different angle.

In another aspect of the present invention, there is provided a latch mechanism having male and female coupling members that mate in a first coupling direction by insertion of a probe into a socket. Once mated a latch on one piece enters a catch channel on the other piece in a second direction. The second direction is inclined to the first direction, preferably by an oblique angle. Accordingly, de-coupling of the male and female coupling members in a direction opposite to the first direction is prevented by engagement between the latch and catch channel. Moreover, the latch and catch channel are not in communication with the socket. This avoids any cross-contamination problems between the socket and catch channel, as might otherwise arise in fluid delivery applications of the latching mechanism. It also enables the catch channel to include different characteristics to the socket.

In the exemplary embodiments the latch is retained by the male coupling member in a sliding arrangement. The latch slides relative to the male coupling member in the second direction. The latch is biased in the second direction to extend further from the male coupling member. Here, during insertion, an end of the sliding latch abuts an end face of the socket and moves against its bias in a direction opposite to the second direction to allow the male coupling member to be inserted. Accordingly, during insertion the sliding latch moves along the female coupling members end face. When the coupling members are mated, the latch and catch channels are aligned. Thus the latch enters the catch channel due to the bias. To de-couple the coupling, the latch is pulled against the bias and in the direction opposite to the second direction. Once the latch is clear of engagement with the catch channel, further relative movement in the direction opposite to the second direction effects de-coupling of the members in the direction opposite to the first direction. Thus there is provided a push-pull latch mechanism that can be coupled and de-coupled in single movements.

Preferably, the second direction is inclined to the first direction by an acute angle. The angle may be between more than 5° or more than 15° or more than 25° or more than 40° and less than 85° or less than 75° or less than 65° or less than 50°.

In the exemplary embodiments the male coupling member and female coupling member include a probe and socket respectively. Coupling/de-coupling is achieved by insertion/withdrawal of the probe into/from the socket. The coupling members each include a first fluid conduit, the first fluid conduits being aligned when the coupling members are mated to form a fluid passageway. Preferably, the fluid passageway takes any path through the coupling. In the preferred embodiments, the fluid passageway is straight. In one exemplary embodiment, the fluid conduits are straight and the fluid passageway has an axis parallel to the second direction. In another exemplary embodiment, the fluid conduits are non-linear. Thus the fluid conduits bend. For instance, the male coupling member includes a first portion of the fluid conduit that is parallel but preferably coincident with the first direction and a second portion of the fluid conduit that is angled with respect to the first direction. The fluid conduit is continuous. The second portion of the fluid conduit includes an aperture on the circumferential face of the probe. The female coupling member also includes first and second portion of fluid conduit. The first portion is parallel to the first direction. The axis of the first portion is spaced from the axis of the first portion in the male coupling when mated. The second portion of the female member's fluid conduit is angled to the first portion. The second portion includes an aperture on the circumferential face of the socket.

Preferably, the latch comprises at least one elongate member. In the exemplary embodiments, the latch comprises a plurality of elongate members. Two or more elongate members are preferred as they increase the rotational stiffness of the coupling. Accordingly, the catch channel comprises a plurality of channels. The channels are not in communication with the socket. In the preferred embodiments the elongate members are held together by a cross-member. The cross-member includes means to enable the latch to be easily operated, for example a part giving a mechanical advantage to the operation.

Preferably the latch includes a reduced strength area. The reduced strength area may allow the latch to fracture at a given load in order to decouple the latch. The reduced strength area may be formed by one or more notches. The reduced strength area may be formed in the latch along the plane of coupling.

In a further aspect of the present invention, there is provided a method of latching male and female coupling members. The method includes inserting a male coupling member in to a female coupling member by moving a probe relative to a socket in a first direction. During insertion, continuous movement in the first direction causes a latch to enter a channel in a second direction. The channel is separate to the socket. The coupling is de-coupled by continuously moving the latch in a direction opposite to the second direction.

The method may include latching male and female coupling members as herein described.

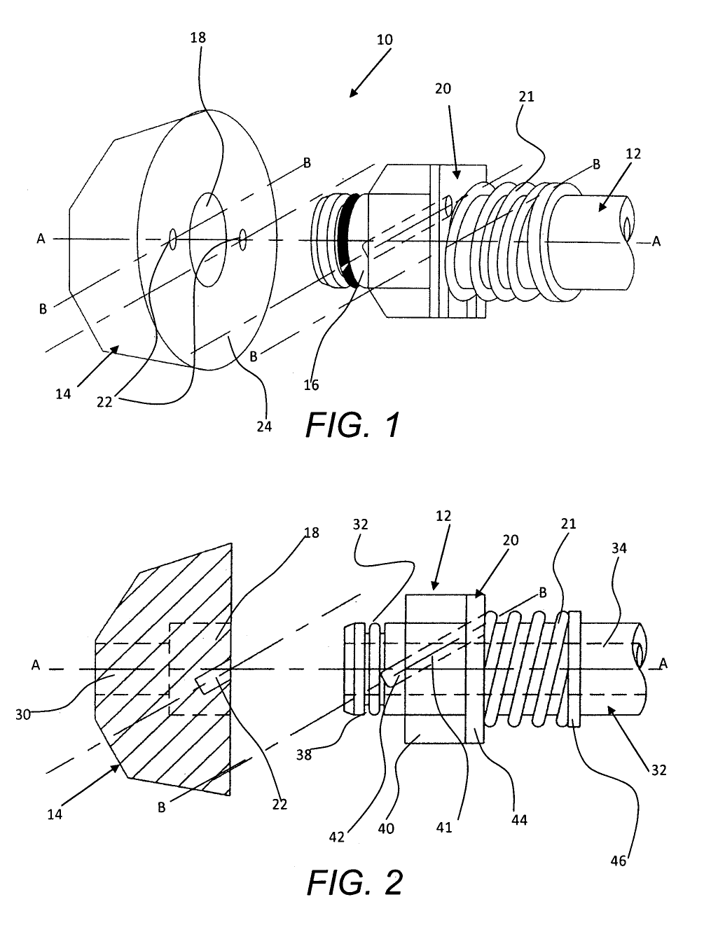

FIG. 1 is a perspective view of a latch mechanism according to a first embodiment of the present invention.

FIG. 2 is a side view of the latch mechanism in an un-mated position

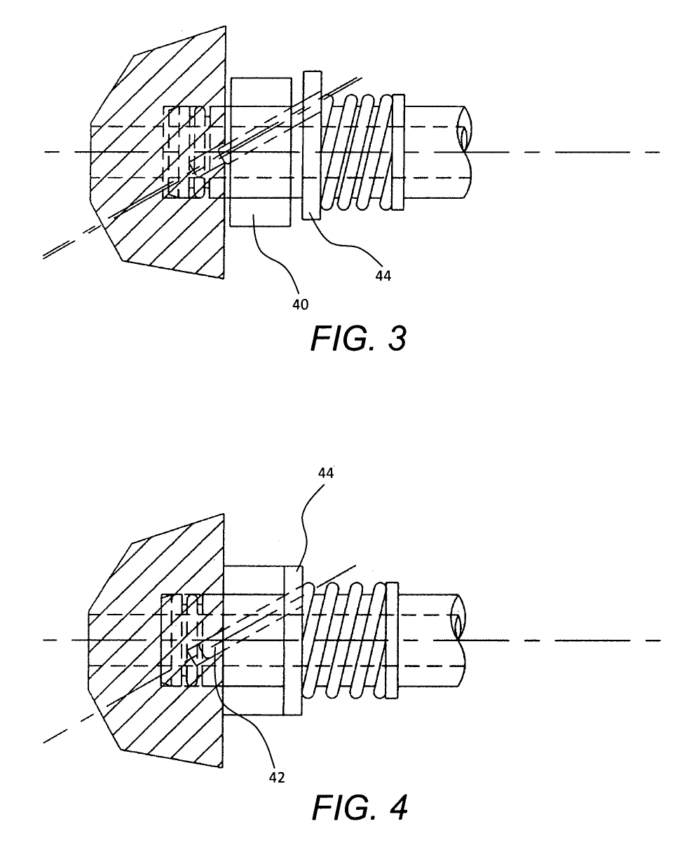

FIG. 3 is a side view of the latch mechanism in a nearly mated position.

FIG. 4 is a side view of the latch mechanism in a mated position.

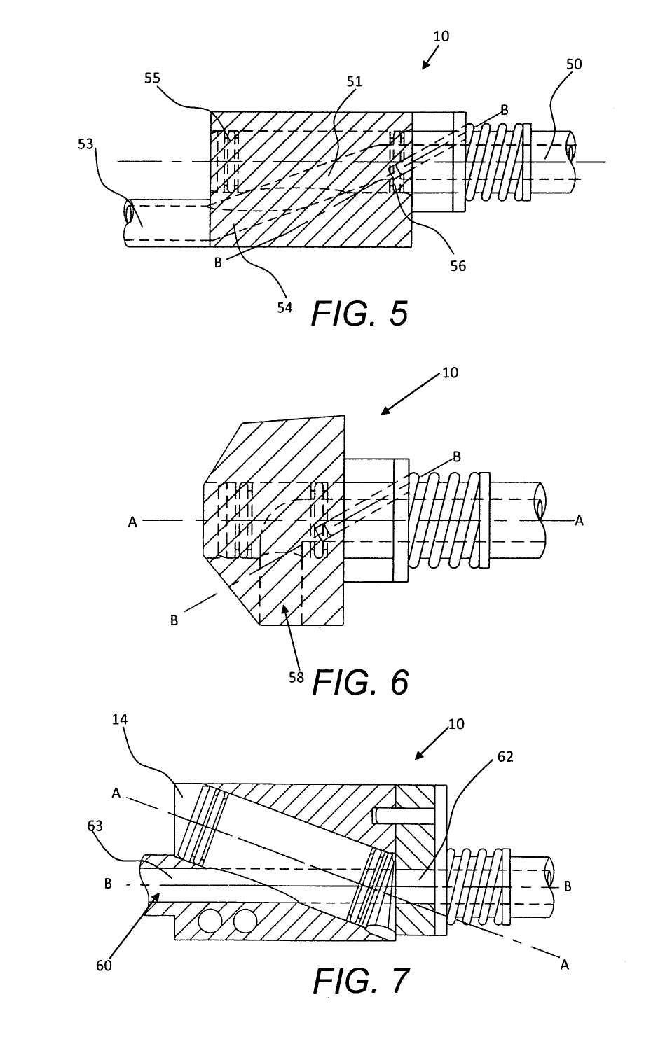

FIG. 5 is a side view of a latch mechanism according to a second embodiment in a mated position.

FIG. 6 is a side view of a latch mechanism according to a third embodiment in a mated position.

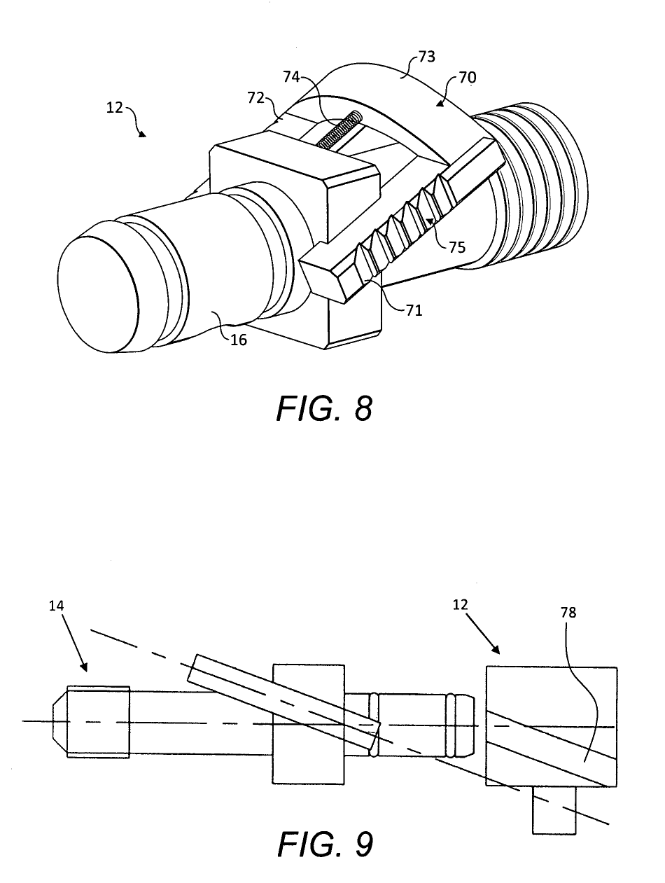

FIG. 7 is a side view of a latch mechanism according to a fourth embodiment in a mated position.

FIG. 8 is a perspective view of a male member of a latch mechanism according to a fifth embodiment.

FIG. 9 is a side view of FIG. 8;

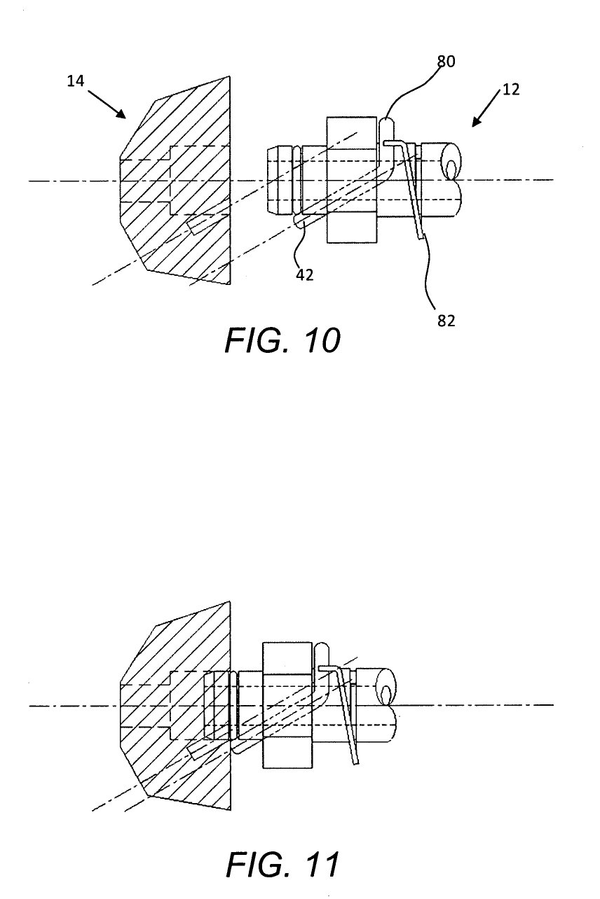

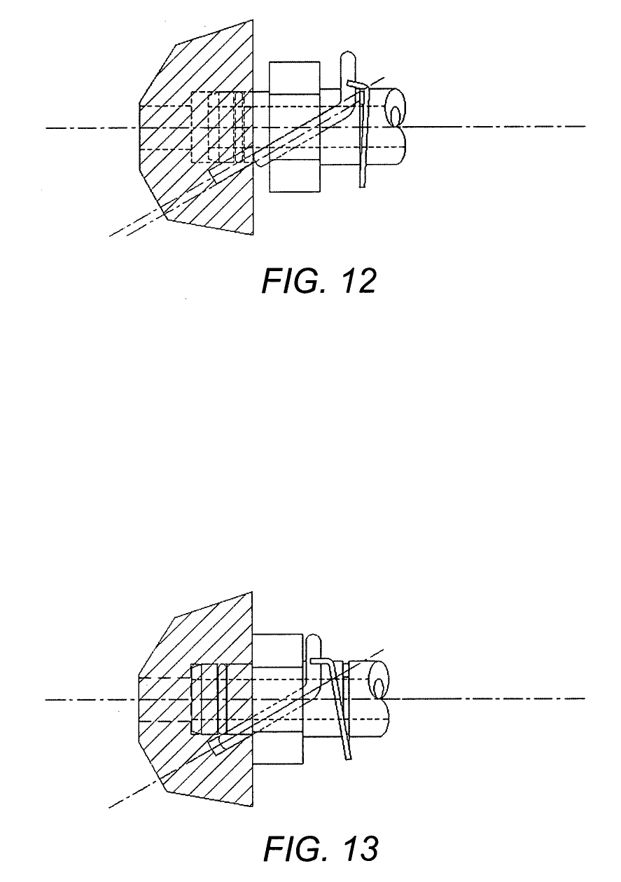

FIGS. 10 to 13 show a coupling sequence of a further embodiment;

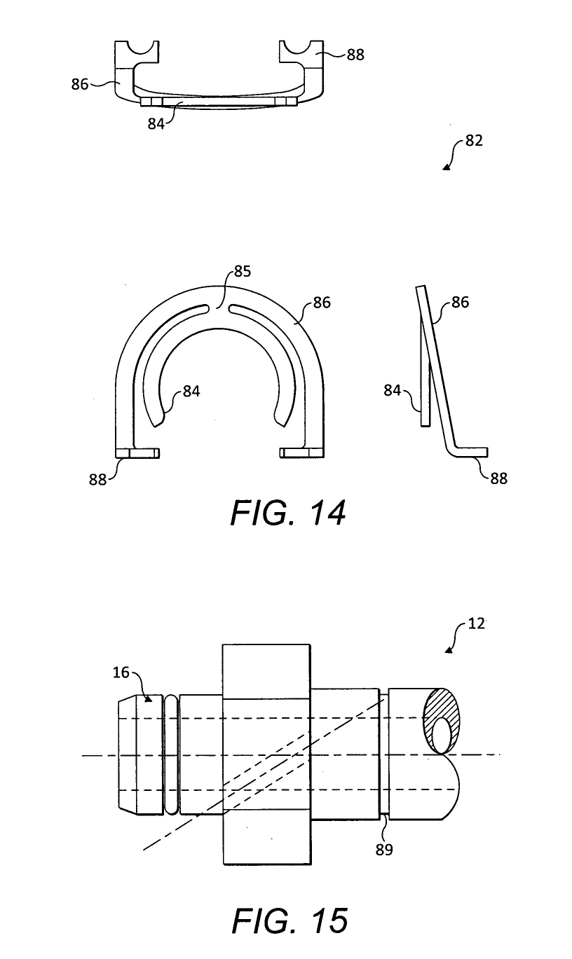

FIG. 14 shows a top, side, and front schematic view of a sprung cir-clip;

FIG. 15 is a side view of a male coupling for receiving the sprung cir-clip;

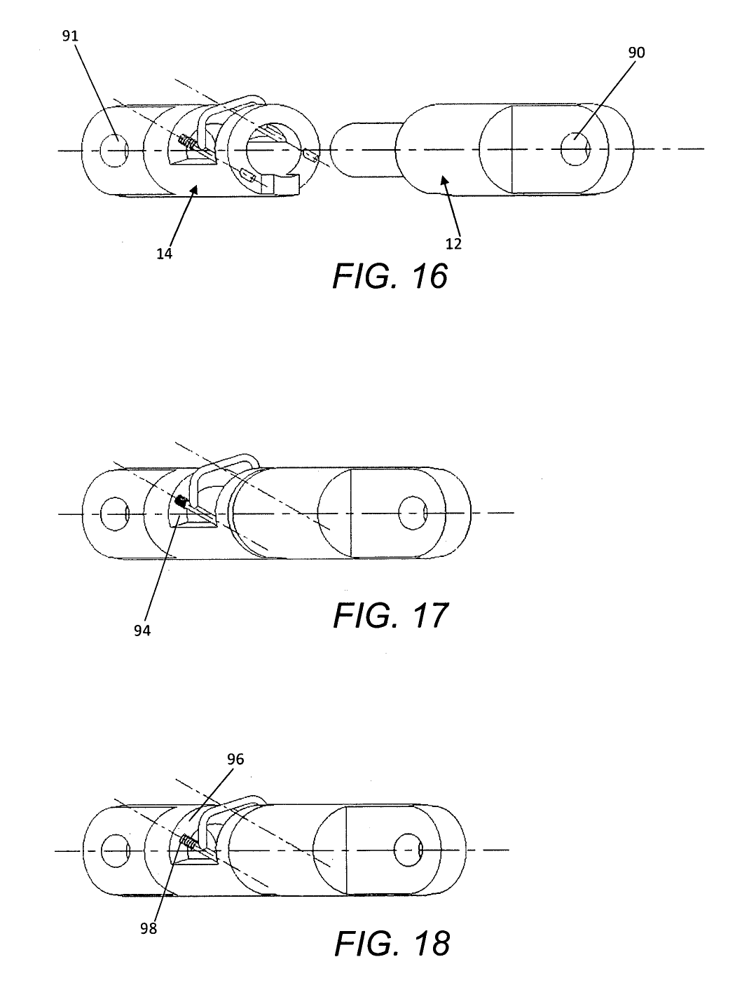

FIGS. 16 to 18 show a coupling sequence of a further embodiment;

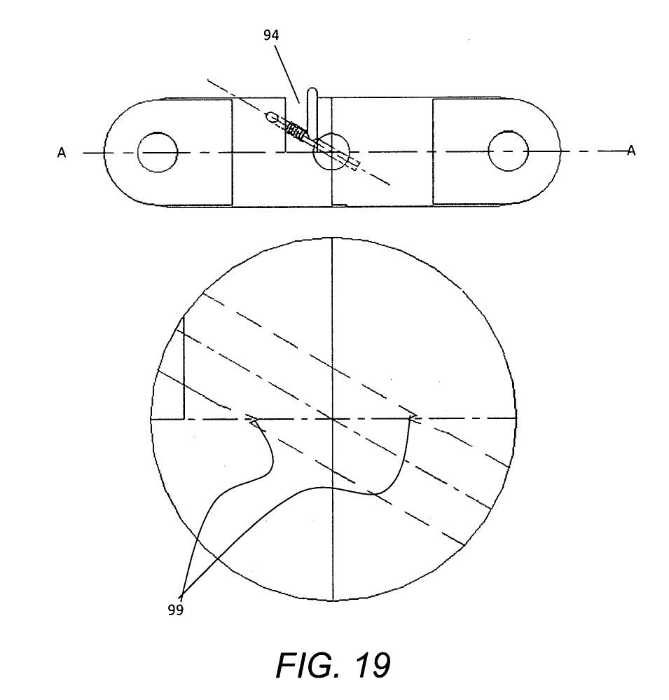

FIG. 19 is a side view of FIG. 18;

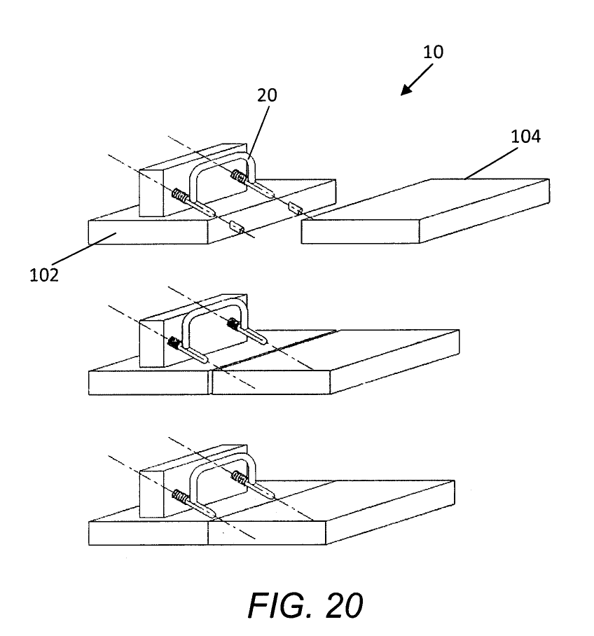

FIG. 20 shows a coupling sequence of a further embodiment particularly suited for use with sliding doors;

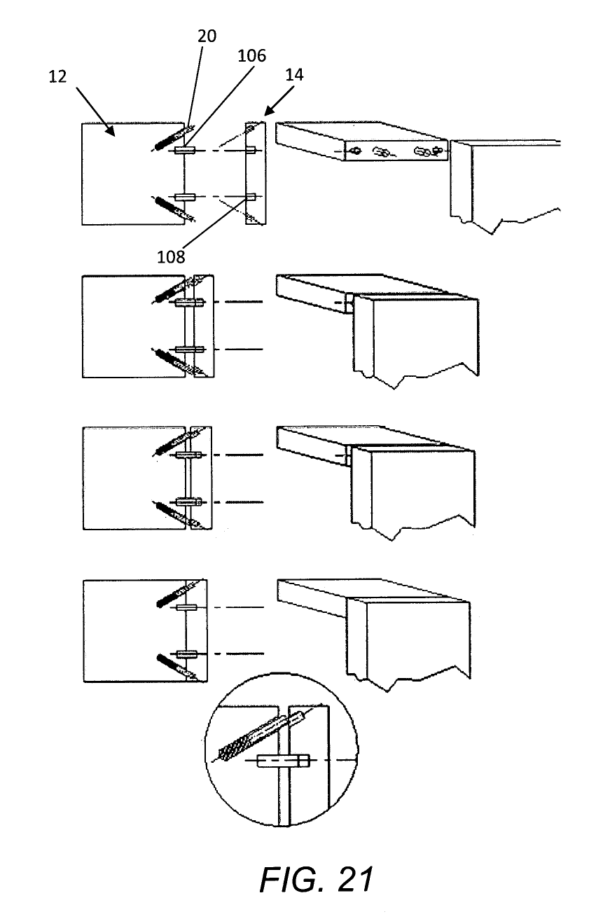

FIG. 21 shows a coupling sequence of a further embodiment particularly suited for assembly of flat packed furniture.

As shown in FIG. 1, a latch mechanism 10 comprises a male coupling member 12, and a female coupling member 14. The male coupling member 12 includes a probe 16. The female coupling member 14 includes a socket 18. The latch mechanism 10 is coupled/de-coupled by inserting/withdrawing the probe from the socket in a first direction (A-A).

A latch 20 is slidably mounted on the male coupling member 12, in a second direction (B-B). A compression spring 21 biases the latch 20 so that the latch extends further from the male coupling member 12. Catch channels shown here as two holes 22 for receiving a part of the latch 20 are formed in the female coupling member. The holes 22 extend from a front face 24 of the female member 14 in the second direction (B-B).

In use, the latch mechanism 10 is coupled by continuous relative movement in the first direction between the male and female coupling members, between limit positions. Accordingly, during insertion, the latch abuts the front face 24 of the female member. Further movement causes the latch to slide relative to the probe in the second direction and against its bias, which allows the probe to further advance into the socket. In doing so, the contact point between the front face and latch also moves along the front face. When the probe is fully inserted, the latch is aligned with the holes 22. Consequently, due to the bias of the spring 21, the latch 20 enters the holes 22, in a manner to be described in detail.

Because the second direction is inclined to the first direction, when in the mated position, de-coupling of the latch mechanism is prevented by engagement between the latch 20 and the holes 22. The engagement creates a shearing force in the parts of the latch within the holes 22. Thus the load carrying characteristics of the latch mechanism is determined by the shear strength of the material used for the latch.

Accordingly, to de-couple the latch mechanism the latch 20 is moved relative to the female member 14 against its bias and in the second direction B-B. This withdraws the latch from the holes 22. Once removed from engagement, the male and female members are free to de-couple by relative movement of probe 16 and socket 18 in the first direction A-A. The movement is continuous, between the end positions. The force effecting the movement can be applied all in the first direction or all in the second direction. It will be appreciated that the force effecting the movement could also be a summation of forces in both directions.

Referring to FIG. 2, it can be seen that the female coupling member 14 includes a stepped through bore, having an axis along the first direction A-A. The widest section of the stepped through bore comprises the socket 18. A narrower section forms a straight fluid conduit 30 between a conduit fitting (not shown) and an end face of the socket.

The male coupling member 12 comprises a tubular section 32. One end of the tubular section comprises the probe 16. A straight fluid conduit 34 is formed between an end face of the probe 16 and a conduit fitting (not shown). A sealing ring 36 is arranged in an annular groove 38 formed toward the probe's distal end. The male coupling member 12 includes a collar 40. The collar 40 is arranged fast to the male member 12. Two through holes 41 are formed in the collar 40 along the second direction.

The latch 20 comprises two prongs 42 connected by a plate 44. The plate is arranged, in use, perpendicularly to the first direction. Accordingly, the prongs 42 are secured fast to the plate 44 at an angle. The prongs locate in the through holes 41. Accordingly, the latch is restrained by the male member's collar 40 to slide in the second direction.

The plate 44 is substantially U-shaped. This allows the plate 44 to be assembled to the male member by sliding the prongs 42 into the holes 41. Once assembled, the spring can be arranged about the tubular male member 16 with one end abutting a rear face of the plate 44. A circlip 46 can then be arranged on the male member to give the spring 21 a fixed point to operate against. The spring 41 thereby biases the plate 44 against the collar 40. In this position, the pins extend from the collar 40.

Referring to FIG. 3, the probe is inserted in to the socket 18, which, as herein described, urges the latch 20 to move against its bias. Accordingly, the plate 44 can be seen to have moved to be spaced from the collar 40. When the probe is fully inserted, the pins 42 are aligned with the holes 22. Thus the spring biases the pins to move in the second direction into the holes 22. To this end, the distal ends of the prongs 42 are rounded to aid insertion in to the holes 22. As shown in FIG. 4, when latched, the fluid conduit 30 in the female member is coincident with the fluid conduit 34 in the male member. A straight fluid passageway is thereby formed. When fluid is applied to the passageway, it is maintained therein by the sealing ring 36. It will be appreciated that the arrangement of the sealing ring 36 will create separation forces that are dependent on the fluid pressure. The separation forces are carried by the latch mechanism as herein described.

Referring to FIG. 5, a second embodiment is shown wherein the latch mechanism 10 is substantially as herein described. However, rather than the fluid conduits in the male and female members being straight they are non-linear and include bends or elbows. The fluid conduits in the male and female members remain continuous and align when the coupling is mated to create a fluid passageway. Here, however the fluid conduits in the male and female members terminate on a circumferential face of the probe and socket respectfully. Accordingly, the male member includes a first position 50 of the fluid conduit that is parallel to the insertion direction and a second portion 51 inclined by an angle. The female member also includes a first portion 52 of the fluid conduit that is parallel to the insertion direction but arranged, when mated, to be spaced from the first portion of the male member. A second portion 54 of the fluid conduit in the female member extends at an angle to the insertion axis. This arrangement allows first and second sealing rings 55,56 to be arranged about the probe and/or the socket in order to create a zero net separation force, or a net closing force.

Referring to FIG. 6, a third embodiment is shown wherein the fluid passageway 58 incorporates a 90° elbow. Here the fluid conduit in the female member is straight and inclined to an angle of approximately 90° to the insertion direction.

Referring to FIG. 7, a fourth embodiment is shown wherein the latch mechanism 10, when mated in use, comprises a straight fluid passageway 60. Here, the male member comprises a bent rod. One end of the bent rod comprises a probe 16 and the other end of the bent rod includes a straight through bore 62 that terminates on a circumferential face of the probe. Because, when mated in use, the fluid passageway is arranged in a second direction B-B, a latch 20 and collar 40 (substantially as herein described) slide parallel to the second end of the bent rod. The female member also includes a socket 14 inclined to a through bore 63 that terminates on a circumferential face of the socket. The latch mechanism operates as herein described.

FIGS. 8 and 9 show a male member of a latch mechanism according to a fifth embodiment. Here, the male member is substantially as herein described and comprises a probe 16 and collar 40. However, the latch comprises a sliding clip 70. The clip 70 slides along a second direction within open channels formed in the collar 40. The clip is biased to extend further from the collar by a tension spring 74. The clip 70 comprises two elongate arms 71,72 connected by a resilient cross-member 73. The resiliency of the cross-member 73 allows the arms to slightly flex toward and away from each other. The arms 71,72 include a series of notches 75 on the outside to aid gripping of the clip 70. Each arm 71,72 also includes a bulge on their distal ends. FIG. 9 shows the male member 12 about to couple with a female member 14 that is substantially as herein described except that the catch channels here comprise open channels 78 for receiving the arms 71,72. The latch mechanism operates as herein described. When the arms 71,72 are located in the channels 78, the clip locks in place by the bulges entering corresponding recesses. Accordingly, in order to withdraw the latch from the catch channels, a tool is needed to first release the bulges from the recesses. Thus the clip includes anti-vandal means, which stops the latch mechanism from being (either accidentally or deliberately) easily decoupled.

FIGS. 10 to 13 show a coupling sequence of a further embodiment. Here, the latch mechanism works substantially as herein described, however, the latch is formed from a continuous bent rod 80, end portions thereof forming the prongs 42, and rather than the latch being biased by a spring, a sprung cir-clip 82 is used.

The sprung cir-clip 82 is shown in more detail in FIG. 14. A first portion 84 of the cir-clip is resiliently coupled at joint 85 to a second portion 86. The second portion 86 extends at angle to the first portion. Accordingly, as the second portion is moved towards the same plane as the first portion, the resilient joint 85 biases the second portion back towards its starting position. The second portion includes bent ends 88 for engaging the latch. Suitably the sprung cir-clip 82 is formed from by bending a piece of sprung metal.

As shown in FIG. 15, in this embodiment the probe 12 includes an annular groove 89 for receiving the first part 84 of the sprung cir-clip 82. Accordingly, the first part 84 is sized so as to snap-fit over the probe 16 when aligned with the annular groove 89. Consequently, the sprung cir-clip becomes held relative to the probe. Thus, the sprung cir-clip provides a bias to the latch.

In a further embodiment, and referring to FIGS. 16-19, the male 12 and female 14 coupling members include apertures 90, 91 on their distal ends for enabling a rope to be connected thereto. The male coupling member 12 further includes a projection and the female coupling member an indent such that rotational alignment is achieved. It will be appreciated that the projections and indent may be on either the male or female member.

The latch mechanism operates substantially as herein described. However, a slot 94 is formed in the male coupling 12 and the latch is accessible through the slot. Furthermore, one side 96 of the slot acts and as a stop for a compression spring 98 to act against.

FIG. 19 shows a side view of the latch mechanism. The enlarged portion shows two notches 99 formed in the prongs 42 of the latch. The notches 99 are aligned along the de-coupling axis A-A of the latch mechanism.

Consequently, the notches 99 provide a predetermined fracture point through the prongs. Accordingly, a known break-out strength can be imparted on the latch mechanism, at which point the pins will shear and the parts be able to de-couple. It will be appreciated that such notches could be incorporated into any of the embodiments herein described.

Referring to FIG. 20, an embodiment is shown that is particularly suited to use with sliding doors. Here the male coupling 12 of a latch mechanism 10 is fitted to a sliding door 102 and a female coupling 14 comprises a frame 104. The door slides relative to the frame and a latch housed on the door moves in a plane angled to the doors plane. The latch mechanism operates substantially as herein described.

Referring to FIG. 21, an embodiment is shown that is particularly suited to use with flat packed furniture. Here the latch mechanism forms a self assembled joint. The male coupling 12 comprises one piece and the female coupling 14 the other. As with conventional flat packed furniture, dowel pins 106 ensure the two pieces come together along a correct coupling plane. The latch 20 comprises two sprung pins, each operating within a hole that is angled with respect to the coupling plane. The two sprung pins are angled with respect to the coupling direction to either side. As the joint is made by moving the two pieces together along the coupling plane, the sprung pins compress. Once the joint has been correctly made, holes 108 in the female coupling become aligned with the sprung pins. Consequently, the sprung pins extend into the hole, thereby locking the joint together. The pin may optionally include a release means for withdrawing the sprung pin in order to decouple the joint. It will be appreciated that whilst the embodiment has been described with two pins for stability, the joint would work equally with only one pin.

The latch mechanism herein described provides a push-pull coupling that is able to be coupled and de-coupled under load and that has positive engagement.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A latch mechanism comprising:
a male coupling member that includes a probe;
a female coupling member that includes a socket;
a latch moveably mounted to one of the coupling members; and
a catch channel located on the other of the coupling members that is not in communication with the socket; wherein, in use,
the male and female coupling members are coupled by relative movement in a first direction and the latch enters the catch channel by relative movement in a second direction when the members are mated, wherein the first direction is inclined to the second direction.

2. The latch mechanism according to claim 1, wherein the latch is biased to move in the second direction in order to extend from the respective coupling.

3. The latch mechanism according to claim 1, wherein the latch is slidably mounted to the respective coupling member and restrained to move in the second direction by the coupling member.

4. The latch mechanism according to claim 1, wherein the coupling members are fluid couplings that, when mated in use, define a continuous fluid passageway.

5. The latch mechanism according to claim 1, wherein the latch comprises at least one elongate member.

6. The latch mechanism according to claim 5, wherein the latch comprises a plurality of elongate members connected by a cross-member.

7. The latch mechanism according to claim 1, wherein a locking means is provided between the latch and catch channel so that the latch and catch channel are locked together when the couplings are mated and the lock prevents withdrawal of the latch from the catch channel unless first unlocked.

8. (canceled)

9. A method of latching a latching mechanism comprising:
coupling a male coupling member of the coupling mechanism to a female coupling member of the latching mechanism by relative movement in a first direction; and
causing a latch on one coupling member to engage a catch channel on the other coupling member in a second direction, which is inclined to the first direction, by movement in the first direction.

10. A method of un-latching a latching mechanism comprising:
withdrawing a latch from a catch by relative movement in a second direction; and
causing a male coupling member of the latching mechanism to un-mate from a female coupling member of the latching mechanism by relative movement in a first direction; wherein
the first and second directions are inclined to each other.

11. The method of claim 10 wherein the withdrawal of the latch and un-mating of the coupling members is effected by a force acting in a single direction.

12. (canceled)
